(19) United States
(12) Patent Application Publication
(10) Pub. No.: US 2013/0054690 A1
(43) Pub. Date: Feb. 28, 2013

(54) Systems and Methods for Managing Personal Information

(71) Applicants: Wen Wei, Saratoga, CA (US); Mike Ji, Cupertino, CA (US); Xiaosong Yang, Palo Alto, CA (US)

(72) Inventors: Wen Wei, Saratoga, CA (US); Mike Ji, Cupertino, CA (US); Xiaosong Yang, Palo Alto, CA (US)

(73) Assignee: WEAVER MOBILE, INC., Santa Clara, CA (US)

(21) Appl. No.: 13/221,157

(22) Filed: Aug. 30, 2011

(51) Int. Cl. G06F 15/16

(52) U.S. Cl. 709/204

(57) ABSTRACT

A method for managing a user's personal information, comprises the steps of, managing one or more electronic user profiles; selecting one of the user profiles; joining a virtual room having one or more members; using the selected profile to communicate with the members of the virtual room; and communicating with one or more of the members.

### FIELD OF INVENTION

This invention generally relates to systems and methods for interactive personal information management for mobile devices and, in particular, to systems and methods for exchanging interactive personal information and for communication between users of mobile devices.

### BACKGROUND

Traditionally, personal information (e.g., contact information) has been exchanged between people through direct contact. For instance, people often exchange their phone numbers, email addresses, or home addresses by writing down that information on paper and handing that paper to another person. Alternatively, business cards are often exchanged in face-to-face meetings to exchange contact information. However, this is quite cumbersome, timing consuming, and often times impracticable.

Modern solutions for obtaining another's personal information include searching features on social networking websites or online search tools, where a person's personal information can be searched by looking up that persons' name, email, or other identifying information for a person. Often times this is impracticable since the name, email, or other information about that person is usually not known. Even when a person's full name is known, there may be hundreds of people with that same name, leading to a very small probability of success in searching for a particular person.

In successful exchanges of contact information, contact information is typically stored on various mediums, e.g., a personal address book, an email account, a social networking website, Microsoft Outlook, a cellular phone, a personal digital assistant, or other electronic medium. These types of information management systems involve redundant effort among many users and incur substantial cost due to the duplication of contact information across many mediums. For instance, the same contact information may have been written down on a personal address book, inputted into the contact list of a cellular phone, and saved under a Microsoft Outlook contact.

Furthermore, retrieving personal information to formulate group events can be difficult as well. For instance, if an organizer wants to set up an event to go hiking. The organizer must locate the contact information of those he or she wants to invite, which may be difficult since the contact information can be spread across various mediums. Once found, the next step may require sending out invitations, either by paper or electronically. The organizer may then need to tally up any responses to determine who will be coming. Alternatively, an electronic system such as a meeting scheduler can keep track of responses.

Another way to set up an event is simply to contact each invitee directly, such as through numerous telephone calls or emails messages, which can be quite time consuming. Certain on-line systems also can help organize an event and keep track of reservations for attendance by the invitees. Yet, these too require advance planning and fairly involved organization. In addition, many of these systems require the organizer to select attendees from a manually-created list of acquaintances, such as members of an email address book, which can be laborious by selecting one or more individuals to invite from a large list of email addresses.

Thus, exchanging contact information and creating events, as mentioned above, are quite difficult and require a large amount of effort and time. Therefore, it is desirable to provide systems and methods for personal information management and for seamless communication of personal information between various people.

### SUMMARY OF INVENTION

An object of this invention is to provide methods and systems for location-based personal information management.

Another object of this invention is to provide methods and systems for electronically exchanging personal information using mobile devices by exchanging virtual cards of the users of the mobile devices.

Yet another object of this invention is to provide methods and systems for managing multiple electronic profiles to use in virtual rooms for communication with members of the virtual rooms.

Furthermore, yet another object of this invention is to provide methods and systems for creating a virtual room associated with a physical location so that users at the location can join that virtual room to communicate with other members of the virtual room at the location.

Briefly, the present invention discloses methods and systems for managing a user's personal information, comprising the steps of, managing one or more electronic user profiles; selecting one of the user profiles; joining a virtual room having one or more members; using the selected profile to communicate with the members of the virtual room; and communicating with one or more of the members.

An advantage of this invention is that methods and systems for location-based personal information management are provided.

Another advantage of this invention is that methods and systems for electronically exchanging personal information using mobile devices by exchanging virtual cards of the users of the mobile devices are provided.

Yet another advantage of this invention is that methods and systems for managing multiple electronic profiles to use in virtual rooms for communication with members of the virtual rooms are provided.

Furthermore, yet another advantage of this invention is that methods and systems for creating a virtual room associated with a physical location so that users at the location can join that virtual room to communicate with other members of the virtual room at the location are provided.

### DESCRIPTION OF THE DRAWINGS

The foregoing and other objects, aspects, and advantages of the invention can be better understood from the following detailed description of the preferred embodiment of the invention when taken in conjunction with the accompanying drawings in which:

FIG. 1 illustrates a network topology of the present invention, where mobile devices are connected via a network to store, retrieve, and share business or personal information of the users of the mobile devices.

FIG. 2 illustrates a flow chart of the present invention for managing and communicating personal information with other users via a virtual room using mobile devices.

FIG. 3 illustrates a first side of a virtual card of the present invention displayed on a mobile device.

FIG. 4 illustrates a second side of a virtual card of the present invention displayed on a mobile device.

FIG. 5 illustrates a listing of virtual rooms of the present invention displayed on a mobile device.

FIG. 6 illustrates a top view of a geographical location, where virtual rooms of the present invention are associated to specific physical locations within the geographical location.

### DETAILED DESCRIPTION OF THE PREFERRED EMBODIMENTS

In the following detailed description of the embodiments, reference is made to the accompanying drawings, which form a part hereof, and in which is shown by way of illustration of specific embodiments in which the present invention may be practiced.

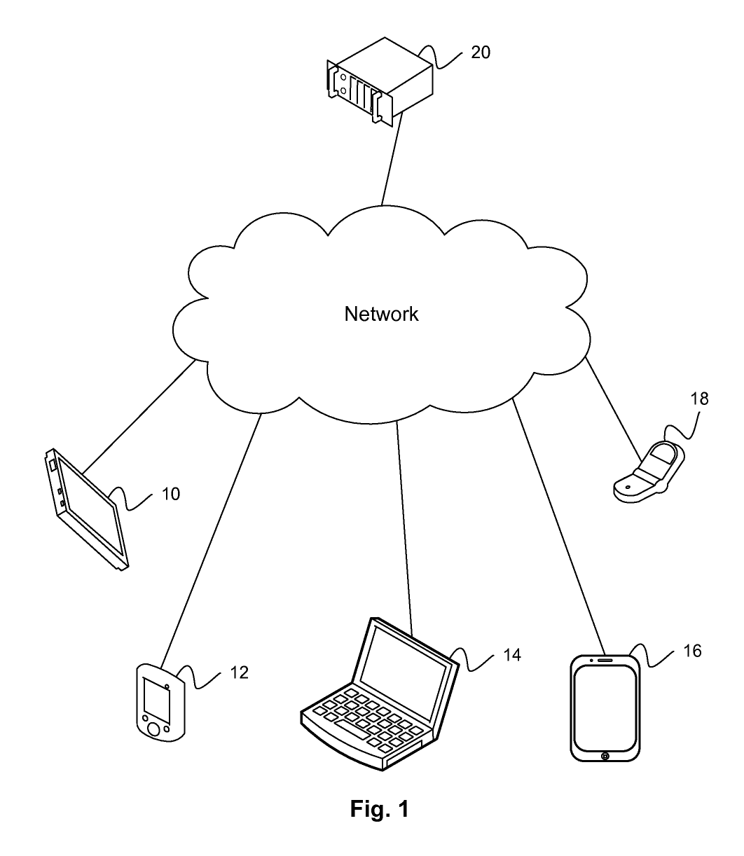

FIG. 1 illustrates a network topology of the present invention, where mobile devices are connected via a network to store, retrieve, and share business or personal information of the users of the mobile devices. Mobile devices 10-18 and a server 20 are connected together via a network (e.g., a cellular network, a satellite network, a Wi-Fi network, Internet, other computer network, or combination of various types of networks). The mobile devices 10-18 are computing devices that execute an application software to communicate with other mobile devices and are able access the server 20. Note that mobile devices can include cellular phones, computer tablets, laptops, personal digital assistants, and other portable computing devices. Furthermore, the mobile devices 10-18 are equipped to identify their location, such that the server 20 can track the location of the mobile devices 10-18.

The mobile devices 10-18 submit their physical locations to the server 20. The server 20 then receives that submission, and stores the location information. A location may be submitted to the server 20 by the mobile devices 10-18 in a variety of forms, including via a proxy, such as the “proper name” of a venue (e.g., restaurant, bar, public place, park, store, arena or other name), a street address, or a location coordinate. The user of a particular mobile device may also manually input the location information of the mobile device. Alternatively, the location can be automatically generated for submission to the server 20, such as by a GPS (Global Positioning System) feature associated with the mobile device to submit a GPS coordinate. Since GPS is usually not available inside buildings, IP addresses of the mobile devices can also be used to determine location information of the mobile devices. Using the location information, a user of one of the mobile devices 10-18 can detect mobile devices of other users within a predefined physical distance (e.g., 100 ft., 500 f ft., etc.) from that user. The user can further request to exchange messages or personal information with the other users.

The server 20 can be one or more physical or virtual servers to provide the functionality as described herein in the present disclosure. In an embodiment of the present invention, a client-server architecture can be implemented, where the server 20 provides server-side functionality via a network to one or more clients (i.e., the mobile devices 10-18) and serves to facilitate communications between the clients. Communication methods between mobile devices 10-18 include voice conversation and messages, personal information exchange (e.g., a virtual card), email messages, SMS text messages, instant messaging messages, electronic message boards, and other forms of electronic communications. A wide variety of networking environments in which a data file (or other data structure) is communicated or transmitted over a network can be used as well.

Once the mobile devices 10-18 are connected via the network, users of the mobile devices 10-18 can host and join virtual rooms to communicate with each other over the network. In hosting a virtual room, a new data object for facilitating communication between members of the virtual room is instantiated in which the user can invite other users to join the room and communicate to each other. A user can join the virtual room by manually selecting on his or her mobile device to add the user to the list of members for that virtual room. Thereby the user is now a member of that virtual room and can communicate with other members of the virtual room, including exchanging virtual cards with the other members.

Each of the users can name a virtual room according to the user's preference. The user may want to group various users in the same room by common physical location of the users, age of the users, a common interest of the users, common schools of the users, familial relationship of the users, common employment/field of work, an event, or other distinctive category.

Once a user has joined a virtual room, the user receives a list of other users that have also joined the room (i.e., members of the room). The server 20 can track this list of members for the virtual room and update the list as necessary depending on whether a member has removed themselves from the virtual room or new users have joined the virtual room. The list of members is displayed on the user's mobile device and can be periodically updated as members leave the virtual room or other users decide to join the virtual room. If the user leaves the room (i.e., is no longer a member), the user no longer receives the current list of members since the user is no longer a member.

Members of the virtual room can privately communicate with each other, such that non-members (i.e., users that are not joined in the virtual room) do not receive these communications. Furthermore, the members of the virtual room can exchange virtual cards with their personal information, write messages on a common message board (e.g., a virtual wall), and write messages to selected members via SMS text, email, or a post on a social networking website.

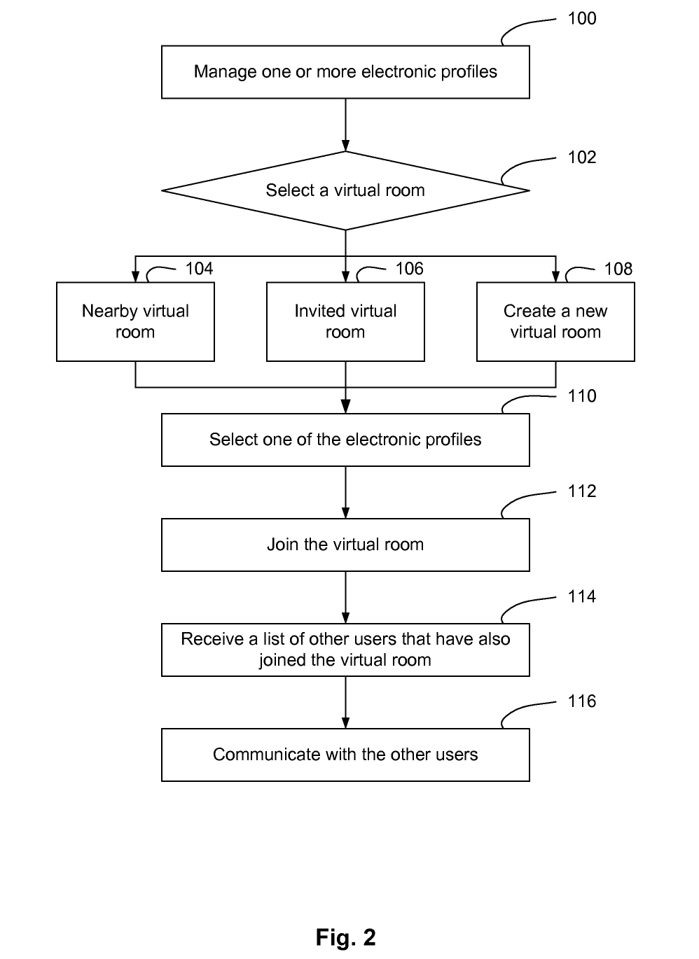

FIG. 2 illustrates a flow chart of the present invention for managing and communicating personal information with other users via a virtual room. In managing one or more electronic profiles 100, the user can first create one or more electronic profiles he or she wants to use to present themselves in a particular virtual room. The user can further input personal information into the profiles and delete personal information from the profiles. The user may input different personal information to the different profiles.

Various profiles with different personal information about the user can aid in partitioning the user's personal information from other users according to the user's preferences. For instance, the user may have a profile for the user's family and close friends, where that profile lists the user's full contact information, including work number, cellular phone number, email address, residential address, social networking profile, etc., and any other personal information the user wishes to disclose. For acquaintances, the user may want to prevent having most of the user's personal information exposed to those acquaintances, so the user can create another profile where only a limited amount of personal information is disclosed, such as only having the user's name and email address. In other situations, the user may set up a profile using an alias so that his/her true identity is kept secret from other users. The profiles can be graphically represented by virtual cards, which display the personal information for a particular profile in a card format (e.g., a business card format or other categorized view of personal information).

The user can select a virtual room 102 either by locating a nearby virtual room to join 104, joining a virtual room to which the user was invited 106, or alternatively creating a new virtual room 108. Once a virtual room is selected, the user can select one of the created electronic profiles 110 to have available for other members of that virtual room to access (e.g., view the user's virtual card for that selected profile).

Multiple electronic profiles allow a user to set a particular profile for a particular event or group associated with a virtual room. For instance, in a virtual room where the user's family is members, the user can select a family user profile, where the family profile has a complete listing of the user's personal information. Furthermore, the family user profile may have its own contact list (e.g., a family contact list), which the user can quickly access and find the contact information relating to his or her family. Note, a contact list can also be referred to as a contact circle list.

In a virtual room for finding pick-up basketball games, the user may wish to use a different profile that only reveals his or her name to other members of this virtual room since the user may not personally know many of the other members. Moreover, in a virtual room for a business event, the user may wish to use a work profile with the user's name, employer, work title, work phone number, and work email so that members in this virtual room can view the user's work information. The user's work profile may also have a separate contact list from the other user profiles, so that the user can quickly look for contact information of other users related to his or her work profile. Additionally, the user's various contact lists can have overlapping entries or have mutually exclusive entries as well.

Next, the user can join the virtual room 112 to become a member of that virtual room. Each member of the virtual room receives a list of the current members of the virtual room (i.e., users that have also joined the virtual room) 114. The user can select from the list of members to communicate with those members 116. Other users who have joined that virtual room can access each other's selected profile for that room to find out more information about a particular member. The user can also save certain member profiles or request more information from a member.

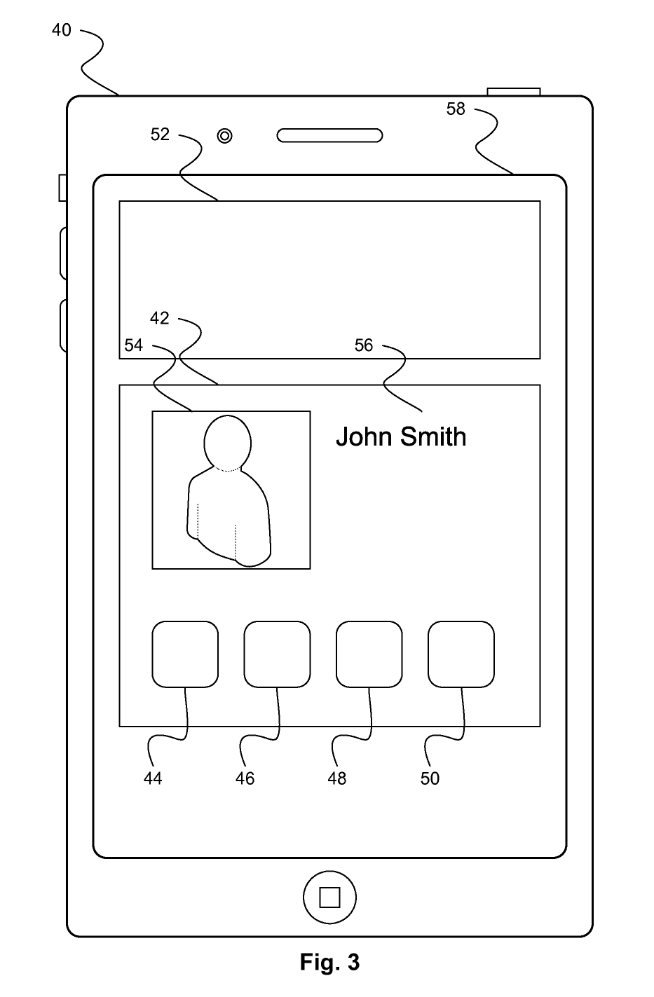

FIG. 3 illustrates a first side of a virtual card of the present invention displayed on a mobile device. A mobile device 40 (e.g., a cellular phone) for making phone calls and receiving and sending data transmissions can display a virtual card 42 of an acquaintance (or any other user for that matter) with contact information of the acquaintance. The acquaintance's contact information comprises one or more of the following: the acquaintance's name, an image representing the acquaintance, a personal phone number, a home phone number, a work phone number, a pager number, a personal email address, a work email address, one or more social networking profiles, a personal interest field, and other personal information of the acquaintance.

The virtual card 42 is a graphical representation of the contact information of a profile for the acquaintance. In the current example, the virtual card 42 can have a front side (i.e., a first side) and a back side (i.e., a second side), which is typical of a physical card. In other embodiments of the invention, a virtual card can have one or more sides for showing the personal information of the acquaintance. Since the virtual card is merely a graphical representation, the virtual card can have one or more sides with each side containing specific information of the acquaintance.

A first side of the virtual card 42 can comprise an image representing the acquaintance 54, the acquaintance's name 56, a phone icon 44, an email icon 46, a Facebook profile icon 48, and a Linked-In profile icon 50. The icons 44-50 can be used to select a method to initiate communication with the acquaintance. If the mobile device 40 uses a touch screen display 58, then the user can press the screen 58 at the location of an icon to select that icon. In other embodiments, the user can scroll through the various icons 44-50 by manipulating one or more buttons of the mobile device 40 to reach and select an icon.

If the user selects the phone icon 44, the mobile device 40 places a call to a phone number listed on the virtual card for the acquaintance. If the virtual card has more than one phone number for the acquaintance, the phone icon 44 can be preset to call one of the phone numbers. Alternatively, the user may manually select one of the phone numbers to call the acquaintance.

If the email address icon 46 is selected, then an email browser can be displayed for inputting a message to be sent to an email address of the acquaintance. If the virtual card for the acquaintance has more than one email address, then the email address icon can be preset to select one of the email addresses. Alternatively, the user can select one or more of the email addresses to message the acquaintance.

The Facebook icon 48 and Linked-In icon 50 can be selected to link to the acquaintances profile for that respective social networking website. For instance, if the user selects the Facebook icon 48, an internet browser opens to load the webpage address associated with that acquaintance's Facebook profile. These icons can generally be referred to as social networking profile icons. Facebook and Linked-In social networking website links are examples of the various social networking profiles for the acquaintance that can be saved on the virtual card. Alternative social networking profiles can also be used, including Twitter, YouTube, MySpace, Google+, and other social networking websites.

Any number of icons can be added to the virtual card, or alternatively, the present icons 44-50 can be configured to use a different contact medium to message the acquaintance. For instance, instead of a Linked-In icon, an IP phone icon can be used in its place. Thus, when the user selects the IP phone icon, an IP phone conversation can be initiated. The IP phone conversation can be based on other applications running on the mobile device 40, including Skype, Vonage, Phone Power, and other IP phone application providers. In addition, five or more icons to select a particular mode for contacting the acquaintance can also be displayed on the mobile device for the user to contact the acquaintance by merely selecting that icon.

A notes area 52 can also be adjacent to the display of the virtual card 42 for displaying notes by the user with respect to the acquaintance. If the user has information that does not fit into any of the saved personal information, the user can input that information into the notes area 52. Additionally, any other personal notes or personal information that the user has relating to the acquaintance can also be inputted into the notes area 52. For instance, the user may want to make note of where they met the acquaintance and what was talked about between the user and the acquaintance.

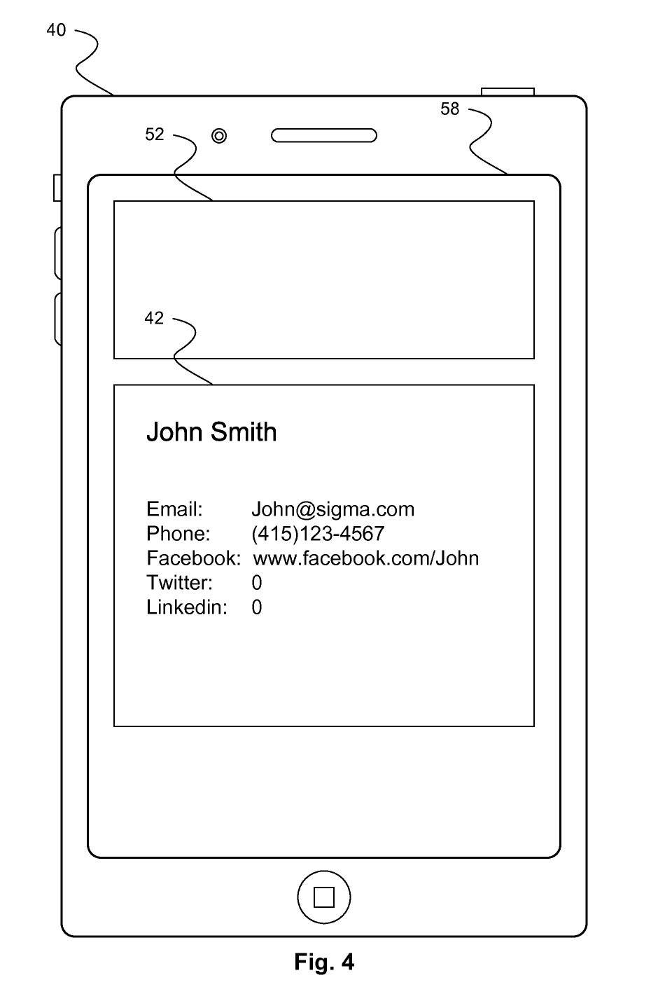

FIG. 4 illustrates a second side of a virtual card of the present invention displayed on a mobile device. On a second side of the virtual card 42, the second side can display the textual information of the acquaintance that relates to the icons 44-50. For instance, the name, email address, phone number, Facebook webpage address and so forth can be displayed in textual format for the user to view. If one of the information categories, e.g., in the Twitter or Linked-In categories, has no information for the acquaintance, a symbol, e.g., “0”, can be displayed to indicate this or the information field can be empty. Alternatively, the categories can be entirely removed from the display on the second side of the virtual card 42.

In alternative embodiments, the second side of the virtual card 42 can also be predefined to display other personal information of the acquaintance or have information related to a particular subject matter. For instance, the second side can comprise of the acquaintance's employment information, including employer's name, work address, work phone, work email, and other work related information of the acquaintance. The second side can also be for other subject matters, including personal interests, professional associations, and other categories of personal information.

The user can also export the contact information on the virtual card of the acquaintance to the address book of the user's mobile device. The virtual card can also be stored according to a contact list of one of the user's profiles. When the virtual card is saved under one of the user's profiles, a new entry for that acquaintance is created in the contact list for that profile and the virtual card is saved under that new entry. New entries can also be imported to the contact list for a user's profile by importing contact information from other sources, including the address book of the user's mobile device, the user's social networking connections, e.g., Facebook friends, email address books, searching for other users by name, or other contact information sources.

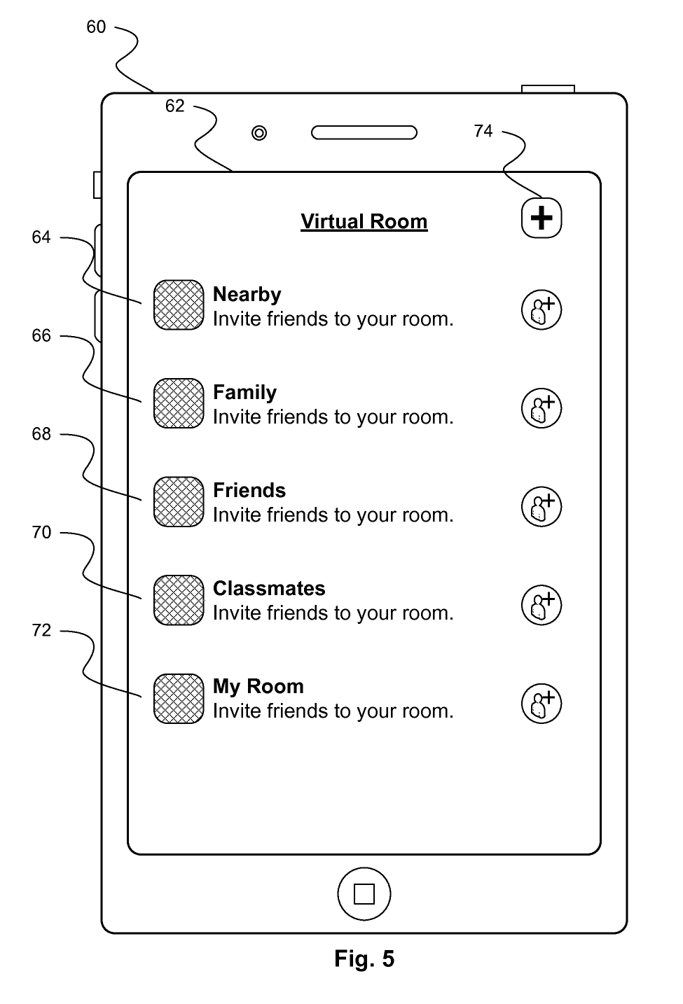

FIG. 5 illustrates a listing of virtual rooms of the present invention displayed on a mobile device. A mobile device 60 has a display screen 62, which displays rows 64-72 of selectable virtual rooms. The user may select one of the virtual rooms to join to initiate communications with members of that selected virtual room. Once the user has joined the virtual room, the user can broadcast a message to the other members or communicate individually with a member of the virtual room. The user can also view the other members' virtual cards and select one or more of these virtual cards to save to the contact list of the user's profile for that virtual room. The user may also request more personal information from those selected members.

Virtual rooms can be created by a user, to which the user can invite other users to join the created virtual room. The user may create virtual rooms and join virtual rooms that have already been created by others. Here, the user is a member of a “Nearby” virtual room, a “Family” virtual room, a “Friends” virtual room, a “Classmates” virtual room, and a “My Room” virtual room.

If the user creates a new virtual room, the user can select icon 74 to create a new virtual room. Once icon 74 is selected, the user can select a name for the virtual room, a user profile to use for that virtual room, a physical location associated with the virtual room, and one or more other users to invite to join the virtual room. The physical location can either be selected from a map or inputted as a mailing address, and can also include multiple different locations selected on the map or by multiple mailing addresses. Mobile devices of users within a predefined range from the physical location of the virtual room can detect the existence of the virtual room.

Invitees can be selected from the users' contact list, saved virtual cards, email addresses, Facebook friends, users within a certain range from the designated physical location of the virtual room, or other locations having contact information. In addition, the user may set a security code for the virtual room such that only other users that know the security code can join the virtual room (in other words, this is a private virtual room, meaning only invitees can join; as opposed to a public virtual room, where any user within a predefined range from the physical location of the virtual room can join that virtual room).

If the virtual room is a public virtual room, then invitations are not necessary since any user can join the virtual room. If the virtual room is private, only the invited guests are allowed to join the virtual room since those users know the security code to access the virtual room. Furthermore, if the invited guests are allowed to invite other guests, then a security code can be distributed to these other guests to use for verification that they have been invited to join. In this way, the user can freely join public virtual rooms and other virtual rooms to which he or she has been invited or has created.

The user can also search for virtual rooms that are “nearby”. Since virtual rooms are associated with a physical location, the server 20 can keep track of the associated locations of the virtual rooms and allow mobile devices that are within a predefined range from the virtual room detect the existence of the virtual room. Once the “nearby virtual” rooms are identified, the user can join that virtual room if they have permission, i.e., if the virtual room is public or the user has been invited to join that virtual room. Virtual rooms can also contain a virtual wall (also referred to as a wall) for posting comments or images by a member for the other members of the virtual room to view and comment upon. The user can also communicate only to select individual members or a specific group of members.

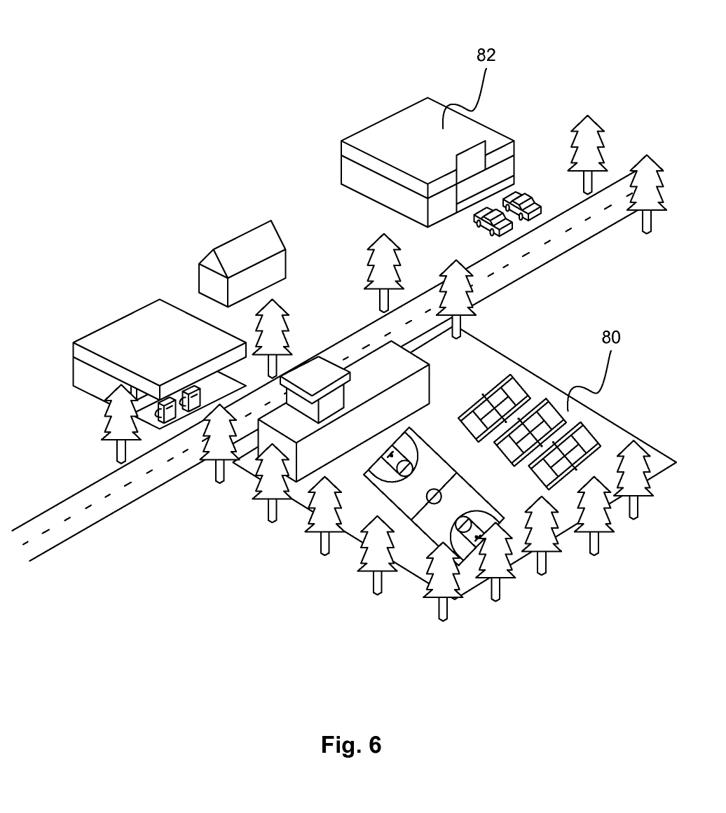

FIG. 6 illustrates a top view of a portion of the street, where a virtual room of the present invention can be associated with one of the physical locations on the street. Virtual rooms can be associated with multiple locations within a geographical vicinity. Here, a “professional group meet-up” virtual room can have the mailing address of a restaurant 82 associated with that virtual room. After users join the group to become members of the group, the members can access other members' virtual cards and exchange communications with the other members that are within a predefined range from the restaurant 82. In particular, a member can communicate directly with another member and request to exchange virtual cards. In addition, the member can request more personal information from the other member.

Two or more virtual rooms can also be associated with identical mailing addresses (or same geographical location). The invitee list and the name of the virtual room can be used to differentiate between the events happening at the same mailing address. For instance, a playground 80 having a single physical mailing address can be used as a physical location for two or more groups hosting an event at the playground. In particular, a “basketball group” virtual room and a “tennis group” virtual room can have their locations associated with the physical address of the playground 80, such that members of each group can quickly identify each other by joining the same virtual room and sending and receiving communications between the members of the respective virtual room. Even at the same location, the members of each virtual room can quickly post messages to determine the event details. Also, the membership of the two virtual rooms at the playground 100 may have some overlap; thus, a user may be a member of the “tennis group” and the “basketball group” virtual rooms.

In alternative embodiments, the personal information of the user and the virtual rooms joined by the user can be tracked to determine user statistics and personal interests of the user. The virtual room membership and activity statistics of the user can be used by event organizers to determine their preferred invitee list. These statistics can be further used for targeted advertisements and other targeted applications. Furthermore, members of a virtual room can be matched to other members that have similar interests or have some shared information. For instance, if any two users have overlapping membership in existing virtual rooms, those two users can be alerted to each other of these common groups.

In further embodiments of the present invention, a virtual room can be associated with a conference. A user can register to attend the conference by using a selected profile of the user to join the virtual room associated with the conference. The personal information from the selected profile is transmitted to the conference organizer (or a conference database) to register the user. Thus, the user can easily register for the conference by joining the virtual room associated with the conference. Furthermore, printers can be set up at the conference to print out information cards with the names and other personal information of the registered attendees. After the user has joined, an information card is printed for the selected user profile and the user is notified of a pick-up location for the information card.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for managing a user's personal information, comprising the steps of,
managing one or more electronic user profiles;
selecting one of the user profiles;
joining a virtual room having one or more members;
using the selected profile to communicate with the members of the virtual room; and
communicating with one or more of the members.

2. The method of claim 1 wherein in the communicating step, a virtual card having contact information corresponding to the selected user profile is transferred to the one or more members.

3. The method of claim 1 wherein in the communicating step, one or more virtual cards having contact information of the members in the virtual room are received and stored under a contact circle list that is associated with the selected user profile.

4. The method of claim 3 wherein the members in the contact circle list are invited to join other virtual rooms and events.

5. The method of claim 3 wherein when the user is using a particular profile, if there are members that is in the contact circle list (associated with the particular profile) in the same virtual room as the user, the user is notified of the presence of these members.

6. The method of claim 1 wherein the virtual room is only accessible by users that have received an invitation to join the virtual room.

7. The method of claim 1 wherein the virtual room is associated with a physical location.

8. The method of claim 7 in the joining step, wherein the members of the virtual room are located within a predefined distance from the physical location.

9. The method of claim 7 in the joining step, an information card is printed for the selected user profile and the user is notified of a pick-up location for the information card.

10. The method of claim 1 wherein the virtual room is associated with a conference and, upon joining the virtual room, personal information corresponding to the selected user profile is transferred to an organizer of the conference to register the user.

11. A method for managing a user's personal information, comprising the steps of,
managing one or more electronic user profiles;
selecting one of the user profiles;
joining a virtual room having one or more members, wherein the virtual room is associated with a physical location and wherein the members of the virtual room are located within a predefined distance from the physical location;
using the selected profile to communicate with the members of the virtual room; and
communicating with one or more of the members, wherein a virtual card having contact information corresponding to the selected user profile is transferred to the one or more members.

12. The method of claim 11 wherein in the communicating step, one or more virtual cards having contact information of the members in the virtual room are received and stored under a contact circle list that is associated with the selected user profile.

13. The method of claim 12 wherein the members in the contact circle list are invited to join other virtual rooms and events.

14. The method of claim 12 wherein when the user is using a particular profile, if there are members that is in the contact circle list (associated with the particular profile) in the same virtual room as the user, the user is notified of the presence of these members.

15. The method of claim 11 wherein the virtual room is only accessible by users that have received an invitation to join the virtual room.

16. The method of claim 11 in the joining step, an information card is printed for the selected user profile and the user is notified of a pick-up location for the information card.

17. The method of claim 11 wherein the virtual room is associated with a conference and, upon joining the virtual room, personal information corresponding to the selected user profile is transferred to an organizer of the conference to register the user.

18. A method for managing a user's personal information, comprising the steps of,
managing one or more electronic user profiles;
selecting one of the user profiles;
joining a virtual room having one or more members, wherein the virtual room is only accessible by users that have received an invitation to join the virtual room, wherein the virtual room is associated with a physical location of a conference, wherein the members of the virtual room are located within a predefined distance from the physical location, wherein, upon joining the virtual room, personal information corresponding to the selected user profile is transferred to an organizer of the conference to register the user, and wherein an information card is printed for the selected user profile and the user is notified of a pick-up location for the information card;
using the selected profile to communicate with the members of the virtual room; and
communicating with one or more of the members, wherein a virtual card having contact information corresponding to the selected user profile is transferred to the one or more members and wherein one or more virtual cards having contact information of the members in the virtual room are received and stored under a contact circle list that is associated with the selected user profile.

19. The method of claim 18 wherein the members in the contact circle list are invited to join other virtual rooms and events.

20. The method of claim 18 wherein when the user is using a particular profile, if there are members that is in the contact circle list (associated with the particular profile) in the same virtual room as the user, the user is notified of the presence of these members.
